(19) United States
(12) Patent Application Publication
(10) Pub. No.: US 2014/0072078 A1
(43) Pub. Date: Mar. 13, 2014

(54) DEVICE, SYSTEM AND METHOD OF WIRELESS COMMUNICATION UTILIZING ONE OR MORE ANTENNA ARRAYS

(71) Applicants: Vadim Sergeyevich Sergeyev, Nizhny Novgorod (RU); Alexander Alexandrovich Maltsev, Nizhny Novgorod (RU); Alexei Vladimirovich Davydov, Nizhny Novgorod (RU); Andrey Vyacheslavovich Pudeyev, Nizhny Novgorod (RU)

(72) Inventors: Vadim Sergeyevich Sergeyev, Nizhny Novgorod (RU); Alexander Alexandrovich Maltsev, Nizhny Novgorod (RU); Alexei Vladimirovich Davydov, Nizhny Novgorod (RU); Andrey Vyacheslavovich Pudeyev, Nizhny Novgorod (RU)

(21) Appl. No.: 13/976,495

(22) PCT Filed: Aug. 29, 2012
(86) PCT No.: PCT/RU2012/000713

§ 371 Date: Jun. 27, 2013

(51) Int. Cl. H04B 7/08

(52) U.S. Cl. CPC H04B 7/08
USPC 375/316

(57) ABSTRACT

Some demonstrative embodiments include devices, systems and/or methods of wireless communication utilizing one or more antenna arrays. For example, a device may include a controller to control one or more antenna arrays for reception of a wireless transmission from a wireless communication device, the controller may be configured to control the one or more antenna arrays to form a beam directed in a first beam direction for receiving the wireless transmission, and to form a second beam to search for at least one second beam direction, different from the first beam direction, to compare the second beam direction to the first beam direction based on at least one predefined criterion, and, based on the comparison, to steer the first beam to the second beam direction for receiving the wireless transmission.

### BACKGROUND

A wireless communication device may be configured to communicate over a millimeter wave (mmwave) wireless communication band. The wireless communication device may utilize a plurality of antennas, e.g., phased array antennas, to overcome a path loss of wireless communication signals over the mmwave wireless communication band.

The plurality of antennas may be connected to a single RF chain via a plurality of phase shifters, e.g., a phase shifter per each antenna element of the plurality of antennas.

According to this configuration, the plurality of antennas may operate as a steerable antenna having a single steerable beam.

The device may steer the steerable antenna to a preferred beam direction for communicating with another wireless communication device. For example, the preferred beam direction may be a direction in which the wireless communication signals received from the other wireless communication device are optimal, e.g., having maximal signal strength. Calculating phase shift coefficients from a measurement of a wireless communication channel for each antenna element may be impossible in this configuration. Instead, the wireless communication device may utilize search procedures, e.g., sector sweeps, which consume a relatively long period of time, to find the preferred beam direction and to steer the steerable antenna to the preferred beam direction.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic illustration of wireless communication between a first wireless communication device and a second wireless communication device, when the second wireless communication device moves from a first location to a second location, in accordance with some demonstrative embodiments.

FIG. 3 is a schematic illustration of wireless communication between first and second wireless communication devices, when a line of sight between the wireless communication devices is blocked, in accordance with some demonstrative embodiments.

FIG. 4 is a schematic illustration of a method of wireless communication utilizing one or more antenna arrays, in accordance with some demonstrative embodiments.

FIG. 5 is a schematic illustration of an article of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Wireless-Gigabit-Alliance (WGA) specifications (Wireless Gigabit Alliance, Inc WiGig MAC and PHY Specification Version 1.0, April 2010, Final specification) and/or future versions and/or derivatives thereof, devices and/or networks operating in accordance with existing IEEE 802.11 standards (IEEE 802.11-2007, IEEE Standard for Information Technology—Telecommunications and information exchange between systems—Local and metropolitan area networks—Specific requirements, Part 11: Wireless LAN Medium Access Control (MAC) and Physical Layer (PHY) Specifications; IEEE 802.11n-2009, IEEE Standard for Information Technology—Telecommunications and information exchange between systems—Local and metropolitan area networks—Specific requirements, Part 11: Wireless LAN Medium Access Control (MAC) and Physical Layer (PHY) specifications, Amendment 5: Enhancements for Higher Throughput; IEEE802.11 task group ac (TGac) (“IEEE802.11-09/0308r12—TGac Channel Model Addendum Document”); IEEE 802.11 task group ad (TGad) (IEEE P802.11ad/D1.0 Draft Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 5: Enhancements for Very High Throughput in the 60 GHz Band), and/or future versions and/or derivatives thereof, devices and/or networks operating in accordance with existing IEEE 802.16 standards (IEEE-Std 802.16, 2009 Edition, Air Interface for Fixed Broadband Wireless Access Systems; IEEE-Std 802.16e, 2005 Edition, Physical and Medium Access Control Layers for Combined Fixed and Mobile Operation in Licensed Bands; amendment to IEEE Std 802.16-2009, developed by Task Group m) and/or future versions and/or derivatives thereof, devices and/or networks operating in accordance with existing Wireless-WirelessHD™ specifications and/or future versions and/or derivatives thereof, units and/or devices which are part of the above networks, and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Orthogonal Frequency Division Multiple Access (OFDMA), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, Long Term Evolution (LTE), LTE advanced, Enhanced Data rates for GSM Evolution (EDGE), or the like. Other embodiments may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

Some demonstrative embodiments may be used in conjunction with suitable limited-range or short-range wireless communication networks, for example, a wireless area network, a “piconet”, a WPAN, a WVAN and the like. Other embodiments may be used in conjunction with any other suitable wireless communication network.

Some demonstrative embodiments may be used in conjunction with a wireless communication network communicating over a frequency band of 60 GHz. However, other embodiments may be implemented utilizing any other suitable wireless communication frequency bands, for example, an Extremely High Frequency (EHF) band (the millimeter wave (mmwave) frequency band), e.g., a frequency band within the frequency band of between 30 Ghz and 300 GHZ, a WLAN frequency band, a WPAN frequency band, a frequency band according to the WGA specification, and the like.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, and/or the like.

The term “station” (STA), as used herein, may include any logical entity that is a singly addressable instance of a medium access control (MAC) and a physical layer (PHY) interface to a wireless medium (WM).

The phrase “access point” (AP), as used herein, may include an entity that contains one station (STA) and provides access to distribution services, via the WM for associated STAs.

The term “beamforming”, as used herein, may relate to a spatial filtering mechanism, which may be used at a transmitter and/or a receiver to improve the received signal power or signal-to-noise ratio (SNR) at an intended receiver.

The phrases “directional multi-gigabit (DMG)” and “directional band” (DBand), as used herein, may relate to a frequency band wherein the Channel starting frequency is above 56 GHz.

The phrases “DMG STA” and “mmWave STA (mSTA)” may relate to a STA having a radio transmitter, which is operating on a channel that is within the DMG band.

The term “sector”, as used herein, may relate to a transmit and/or a receive antenna pattern corresponding to a particular sector, e.g., a sector identifier (ID).

The term “sweep”, as used herein, may relate to a sequence of transmissions, e.g., separated by a short beamforming inter frame space (SBIFS) interval, in which an antenna configuration at a transmitter and/or a receiver is changed between transmissions.

The phrase “sector sweep” (SSW), as used herein, may relate to a reception or a transmission of frames via different sectors, in which a sweep is performed between consecutive receptions and/or transmissions.

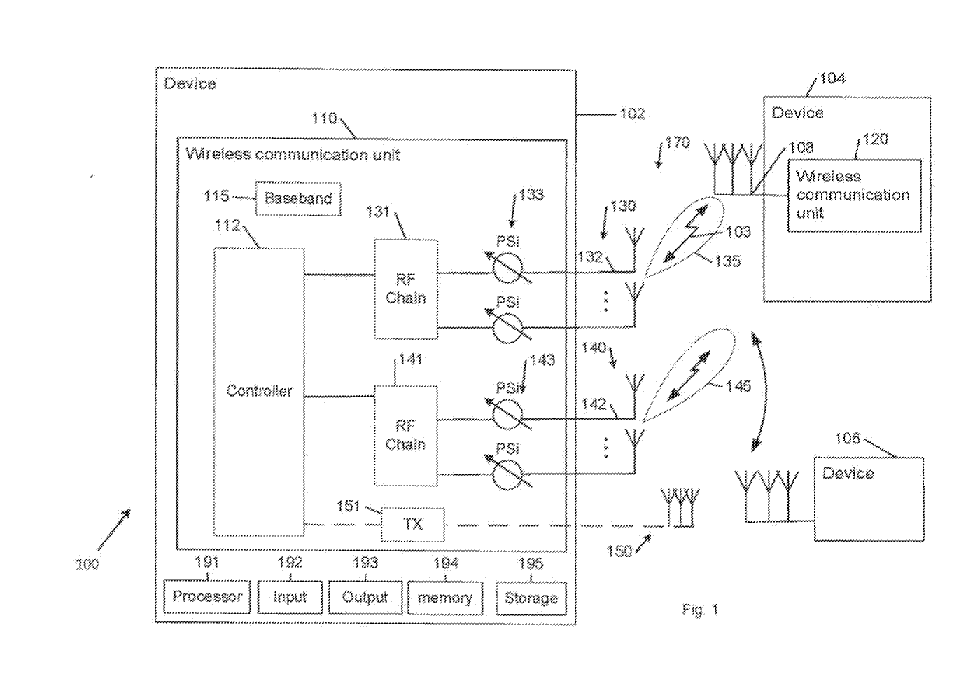

Reference is now made to FIG. 1, which schematically illustrates a block diagram of a wireless communication system 100, in accordance with some demonstrative embodiments.

In some demonstrative embodiments, system 100 may include one or more devices, e.g., devices 102 and 104, capable of communicating content, data, information and/or signals over a wireless communication medium. For example, device 104 may include a wireless communication unit 120, and device 102 may include a wireless communication unit 110.

In some demonstrative embodiments, the wireless communication medium may include, for example, a radio channel, an IR channel, a RF channel, a Wireless Fidelity (WiFi) channel, and the like. In one example, the wireless communication medium may include a DMG channel, e.g., a 60 GHz channel.

In some demonstrative embodiments, wireless communication devices 102 and/or 104 may perform the functionality of DMG stations (“mSTA”). For example, wireless communication devices 102 and/or 104 may be configured to communicate over the DMG.

In some demonstrative embodiments, devices 102 and/or 104 may be suitable for directional communication, e.g., according to a beamforming scheme.

In some demonstrative embodiments, device 102 may include one or more antenna arrays 170 configured to generate at least first and second beams, e.g., simultaneously. In some embodiments, device 102 may include a plurality of antenna arrays. For example, device 102 may include at least a first antenna array 130 and a second antenna array 140, and device 104 may include at least one antenna array 108, e.g., as described below.

In some demonstrative embodiments, first antenna array 130 may include a first plurality of antenna elements 132, and second antenna array 140 may include a second plurality of antenna elements 142. Antenna elements 132 and 142 may be configured to simultaneously emit and/or receive signals in accordance with the beamforming scheme.

In some demonstrative embodiments, wireless communication unit 110 may include a first plurality of phase shifters 133 associated with antenna elements 132 to control phase shifts applied by antenna elements 132. For example, each phase shifter of phase shifters 133 may shift the phase state of a respective antenna element of antenna elements 132.

In some demonstrative embodiments, wireless communication unit 110 may include a second plurality of phase shifters 143 associated with antenna elements 142 to control phase shifts applied by antenna elements 142. For example, each phase shifter of phase shifters 143 may shift the phase state of a respective antenna element of antenna elements 142.

In some demonstrative embodiments, first antenna array 130 may be configured to form a first beam 135 directed to a first direction, e.g., by shifting phase states of antenna elements 132.

For example, shifting the phase states of antenna elements 132, e.g., by phase shifters 133, may provide a constructive and/or destructive interference, configured to steer beam 135 in the first beam direction.

In some demonstrative embodiments, second antenna array 140 may be configured to form a second beam 145 directed to a second direction, e.g., by shifting phase states of antenna elements 142.

For example, shifting the phase states of antenna elements 142, e.g., by phase shifters 143, may provide a constructive and/or destructive interference, configured to steer beam 145 in the second beam direction.

In some demonstrative embodiments, device 102 may utilize a plurality of RF chains for processing signals received by the plurality of antenna arrays, e.g., such that each RF chain of the plurality of RF chains may process signals received from a respective antenna array of the plurality of antenna arrays.

In some demonstrative embodiments, wireless communication unit 110 may include an RF chain 131 configured to process signals received from antenna elements 132, and an RF chain 141 configured to process signals received from antenna elements 142.

In some demonstrative embodiments, device 102 may be configured to receive a wireless transmission 103 from device 104, e.g., over the DMG communication band.

In some demonstrative embodiments, device 102 may include a controller 112 to control at least antenna arrays 130 and 140 for reception of wireless transmission 103 from device 104.

In some demonstrative embodiments, controller 112 may be implemented as part of a base band module 115 of device 102. In other embodiments controller 112 may be implemented as part of any other elements of device 102.

In some demonstrative embodiments, device 102 may be configured to search for a particular beam direction, e.g., an optimal beam direction, to receive wireless transmission 103 from device 104. For example, device 102 may perform a sector sweep to search for the particular beam direction. The particular beam direction may include, for example, a line-of-sight (LOS) direction between devices 102 and 104.

In some demonstrative embodiments, the particular beam direction may become ineffective. For example, device 102 may not be able to receive wireless transmission 103 and/or a quality of the received wireless transmission may be degraded, e.g., via the particular direction.

In some demonstrative embodiments, device 102 may be required to search for a different beam direction to receive wireless transmission 103, e.g., when the particular beam direction becomes ineffective. For example, device 102 may be required to search for the different beam direction due to a movement of wireless communication device 104, and/or when the LOS between devices 102 and 104 is blocked.

In some demonstrative embodiments, searching for the different beam direction, e.g., by performing the sector sweep, may require a relatively long period of time.

In some demonstrative embodiments, network throughput may be reduced and/or an overhead may increase, for example, if the searching for the different beam direction occurs frequently.

In some demonstrative embodiments, device 102 may be configured to search for the different beam direction, e.g., prior to a time at which the particular beam direction becomes ineffective and/or while receiving wireless transmission 103, e.g., as described in detail below.

In some demonstrative embodiments, device 102 may utilize at least one beam to search for the different beam direction, for example, while utilizing one or more beams to receive wireless transmission 103, e.g., as described in detail below.

In some demonstrative embodiments, controller 112 may control one or more antenna arrays 170 to form beam 135 directed in a first beam direction, e.g., the particular beam direction, for receiving wireless transmission 103, and to form beam 145 to search for at least one second beam direction, different from the first beam direction; to compare the second beam direction to the first beam direction based on at least one predefined criterion; and, based on the comparison, to steer first beam 135 to the second beam direction for receiving wireless transmission 103, e.g., as described in detail below.

In some demonstrative embodiments, controller 112 may steer beam 135 to the first beam direction for receiving wireless transmission 103. For example, controller 112 may determine the first beam direction by performing a sector sweep, e.g., as described above.

In some demonstrative embodiments, controller 112 may steer beam 145 to the first beam direction and may steer beam 145 from the first beam direction to search for the second beam direction.

In some demonstrative embodiments, first antenna array 130 may be utilized to form and steer beam 135, and second antenna array 140 may be utilized to form and steer beam 145.

In some demonstrative embodiments, the at least one criterion may include at least one parameter related to a received signal of wireless transmission 103.

In some demonstrative embodiments, the at least one parameter may include a received signal strength of wireless transmission 103, e.g., as described below.

In some demonstrative embodiments, the at least one parameter may include a signal-to-noise ratio (SNR) parameter of a received signal of wireless transmission 103, a signal-to-interference-plus-noise ratio (SINR) of a received signal of wireless transmission 103, and/or any other parameter related to a received signal of wireless transmission 103.

For example, controller 112 may steer first antenna array 130 to the second beam direction, e.g., if a received signal strength of wireless transmission 103 at the second antenna array 140, when steered to the second beam direction, is greater than a received signal strength of the wireless transmission 103 at first antenna array 130, when steered to the first beam direction. For example, the received signal strength of wireless transmission 103, as received via first antenna array 130, when steered to the first beam direction, may decrease, while the received signal strength of wireless transmission 103, as received via second antenna array 140, when steered to the second beam direction, may increase, for example, due to a movement of device 104, due to a LOS between devices 102 and 104 being blocked, and/or due to any other circumstances.

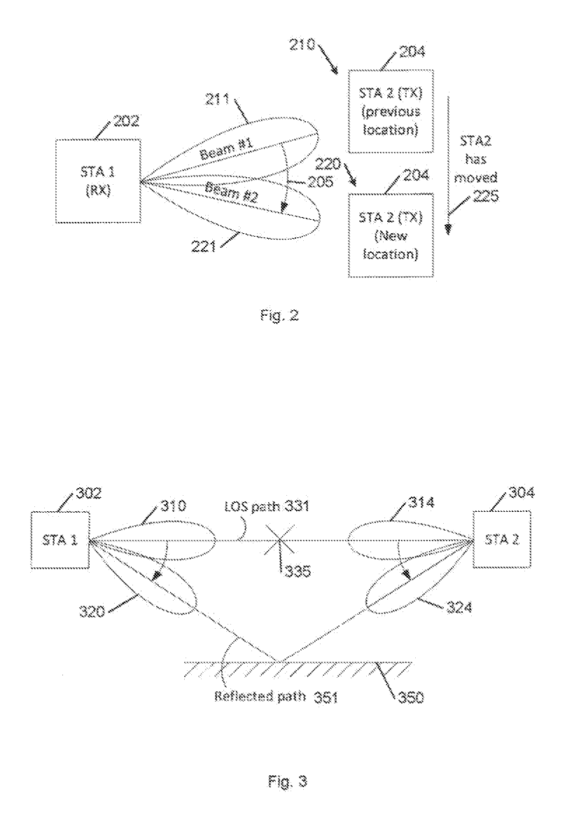

Reference is now made to FIG. 2, which schematically illustrates wireless communication between a wireless communication device 202 and a wireless communication device 204, when device 204 moves from a first location 210 to a second location 220, in accordance with some demonstrative embodiments. In some demonstrative embodiments, device 202 may perform the functionally of device 102 (FIG. 1) and/or device 204 may perform the functionally of device 104 (FIG. 1).

As shown in FIG. 2, device 202 may receive a wireless transmission from device 204, which is located at first location 210, via a first beam direction, e.g., a LOS direction to location 210. For example, one or more antenna arrays, e.g., one or more antenna arrays 170 (FIG. 1), may form a beam 211 directed to the first beam direction. The wireless transmission may be received via the first beam direction at a first received signal strength.

In some demonstrative embodiments, device 202 may from a second beam, to search for a second beam direction, which has a second received signal strength, which is greater than the first received signal strength. For example, the one or more antenna arrays may form a beam 221 directed to the second beam direction.

In some demonstrative embodiments, device 202 may compare the first received signal strength to the second received signal strength. For example, device 202 may receive the wireless transmission via the first beam direction, e.g., as long as the first received signal strength is greater than the second received signal strength.

As shown in FIG. 2, device 204 may move (225) to second location 220. As a result, the first received signal strength may decrease, e.g., such that the second signal strength may be greater than the first signal strength. For example, the second beam direction may include a LOS direction to second location 220 of device 204.

As shown in FIG. 2, device 202 may steer (205) beam 211 to the second beam direction to receive the wireless transmission.

In some demonstrative embodiments, device 202 may steer (205) beam 211 to the second beam direction, for example, without performing any additional searches and/or sector sweeps, e.g., when the first beam direction becomes ineffective.

Referring back to FIG. 1, in some demonstrative embodiments, controller 112 may steer a direction of a transmit antenna array 150 for transmitting to device 104, based on the comparison between the first beam direction and the second beam direction. For example, device 102 may include a transmission module (TX) 151 to control and process wireless transmissions transmitted by transmit antenna array 150.

In some demonstrative embodiments, channel reciprocity and correspondence may be assumed between a receive channel and a transmit channel utilized for communication between wireless communication devices 102 and 104. Accordingly, a transmit beam direction for the transmit channel may be determined based on a received beam direction of the receive channel.

In some demonstrative embodiments, controller 112 may determine a beam direction for transmit antenna array 150, e.g., for transmitting a wireless transmission to device 104, based on the comparison between the first beam direction and the second beam direction, e.g., of antenna arrays 130 and 140.

In some demonstrative embodiments, controller 112 may steer transmit antenna array 150 to the first beam direction, e.g., when antenna array 130 is steered to the first beam direction.

In some demonstrative embodiments, controller 112 may steer transmit antenna array 150 to the second beam direction to transmit the wireless transmission to device 104, if antenna array 130 is steered to the second beam direction to receive wireless transmission 103, e.g., when the first beam direction becomes ineffective.

For example, controller 112 may steer transmit antenna array 150 from the first beam direction to the second beam direction, e.g., when first antenna array 130 is steered from the first beam direction to the second beam direction, if the received signal strength of wireless transmission 103 via beam 145, when steered to the second beam direction, is greater than the received signal strength of wireless transmission 103 via beam 135, when steered to the first beam direction.

In some demonstrative embodiments, device 102 may receive data frames from device 104, and device 102 may transmit acknowledge (ACK) frames to device 104, e.g., in response to the data frames.

In some demonstrative embodiments, controller 112 may utilize the data frames to determine the beam direction of the receive channel and/or the transmit channel to be utilized for communication with device 104. For example, controller 112 may steer antenna arrays 130, 140 and/or 150 based on the received date frames.

In some demonstrative embodiments, device 104 may utilize the ACK frames to determine the beam direction of the receive channel and/or the transmit channel to be utilized for communication with device 102. For example, device 104 may steer antenna array 108 based on the received ACK frames.

In some demonstrative embodiments, controller 112 may steer first antenna array 130 to the second beam direction if the first beam direction is blocked, e.g., by an external element.

In some demonstrative embodiments, controller 112 may steer second antenna array 140 from the first direction to search for a plurality of directions having a relatively high received signal strength, e.g., signal strength peaks, which may, for example, correspond to alternative signal paths for receiving wireless transmission 103.

In some demonstrative embodiments, controller 112 may store, e.g., in a memory 194 and/or a storage 195, information relating to the plurality of directions in association with a plurality of corresponding signal strengths, e.g., a signal strength for each direction of the plurality of directions.

In some demonstrative embodiments, controller 112 may retrieve, e.g., from memory 194 and/or storage 195, a selected direction from the plurality of directions and may steer antenna array 130 to the selected direction, e.g., when the first beam direction is blocked. For example, the selected direction may include a selected direction from the plurality of directions having the received strongest signal strength, e.g., as described below, with reference to FIG. 3.

Reference is now made to FIG. 3, which schematically illustrates wireless communication between a first wireless communication device 302 (STA 1) and a second wireless communication device 304 (STA 2), when a line of sight (LOS) path 331 between devices 302 and 304 is blocked, in accordance with some demonstrative embodiments. In some demonstrative embodiments, devices 302 and 304 may perform the functionality of devices 102 and/or 104 (FIG. 1).

As shown in FIG. 3, device 302 may form a first beam 310 in a first beam direction directed to LOS path 331 for communicating with device 304. Device 304 may form a first beam 314 directed to LOS path 331 to communicate with device 302.

As shown in FIG. 3, devices 302 and 304 may not be able to communicate via LOS path 131, for example, if LOS path 331 is blocked, e.g., by an external element 335.

As shown in FIG. 3, device 302 may form a second beam 320 in a second beam direction directed to a reflected path 351, and device 304 may form a second beam 324 directed to reflected path 351.

As shown in FIG. 3, reflected path 351 may include an alternative path, e.g., reflected from a reflecting element 350, e.g., a wall, a floor, a building and the like.

In some demonstrative embodiments, device 302 may search for at least one second beam direction prior to the blocking of LOS path 331. Device 302 may store the second beam direction, e.g., in memory 194 and/or storage 195 (FIG. 1). For example, device 320 may search for a plurality of directions having a relatively high received signal strength, and may store information related to the plurality of directions, e.g., as described above. If LOS path 331 is blocked, device 302 may select a direction, e.g., the second beam direction, having the strongest signal strength from the plurality of directions. Device 302 may retrieve the information related to the second beam direction, e.g., from memory 194 and/or storage 195 (FIG. 1).

In some demonstrative embodiments, device 302 may steer one or more antenna arrays to the second beam direction, e.g., if LOS path 331 is blocked, in a relatively short period of time without performing any additional searches and/or sector sweeps.

Referring back to FIG. 1, in some demonstrative embodiments, controller 112 may utilize beam 145 for communicating with another wireless communication device 106. For example, controller 112 may control second antenna array 140 for communicating with wireless communication device 106.

In some demonstrative embodiments, controller 112 may steer second antenna array 140 to search for the second beam direction during one or more time periods, when communication with wireless communication device 106 is inactive, for example, during one or more inter-frame space periods.

In one example, device 102 may simultaneously communicate with wireless communication device 104 and wireless communication device 106. Device 102 may utilize first antenna array 130 to form first beam 135 directed in the first beam direction, e.g., the LOS direction to device 104, for communicating with device 104. Device 102 may utilize second antenna array 140 to form a second beam directed in another beam direction, e.g., a LOS to wireless communication device 106, for communicating with wireless communication device 106. Controller 112 may steer second antenna array 140 to search for the second beam direction to be utilized for communication with device 104, during one or more time periods, e.g., during inter-frame space periods, when communication with wireless communication device 106 is inactive.

In another example, device 102 may simultaneously communicate with a plurality of wireless communication devices utilizing a plurality of beams directed to a plurality of different beam directions. Controller 112 may utilize one or more time periods, when a communication between device 102 and one or more devices of the plurality of wireless communication devices is inactive, e.g., during inter-frame space periods, for steering and searching for other beam directions to be utilized for communication with one or more other devices of the plurality of wireless communication devices, which are currently communicating with device 102. For example, device 102 may include an AP and the plurality of devices may include a plurality of mobile STAs (MS). According to this example, controller 112 may track positions of active MSs of the plurality of MSs utilizing beams of inactive MSs of the plurality of MSs, and may reduce a time period required for searching for a MS.

In some demonstrative embodiments, wireless communication devices 102, 104 and/or 106 may include, for example, a PC, a desktop computer, a mobile computer, a laptop computer, a notebook computer, a tablet computer, a server computer, a handheld computer, a handheld device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

Wireless communication devices 102, 104 and/or 106 may also include, for example, one or more of a processor 191, an input unit 192, an output unit 193, memory unit 194, and storage unit 195. Wireless communication device 102 may optionally include other suitable hardware components and/or software components. In some demonstrative embodiments, some or all of the components of wireless communication device 102 may be enclosed in a common housing or packaging, and may be interconnected or operably associated using one or more wired or wireless links. In other embodiments, components of one or more of wireless communication device 102 may be distributed among multiple or separate devices.

Processor 191 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 executes instructions, for example, of an Operating System (OS) of wireless communication device 102, and/or of one or more suitable applications.

Input unit 192 includes, for example, a keyboard, a keypad, a mouse, a touch-screen, a touch-pad, a track-ball, a stylus, a microphone, or other suitable pointing device or input device. Output unit 193 includes, for example, a monitor, a screen, a touch-screen, a flat panel display, a Cathode Ray Tube (CRT) display unit, a Liquid Crystal Display (LCD) display unit, a plasma display unit, one or more audio speakers or earphones, or other suitable output devices.

Memory unit 194 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 includes, for example, a hard disk drive, a floppy disk drive, a Compact Disk (CD) drive, a CD-ROM drive, a DVD drive, or other suitable removable or non-removable storage units. Memory unit 194 and/or storage unit 195, for example, may store data processed by wireless communication device 102.

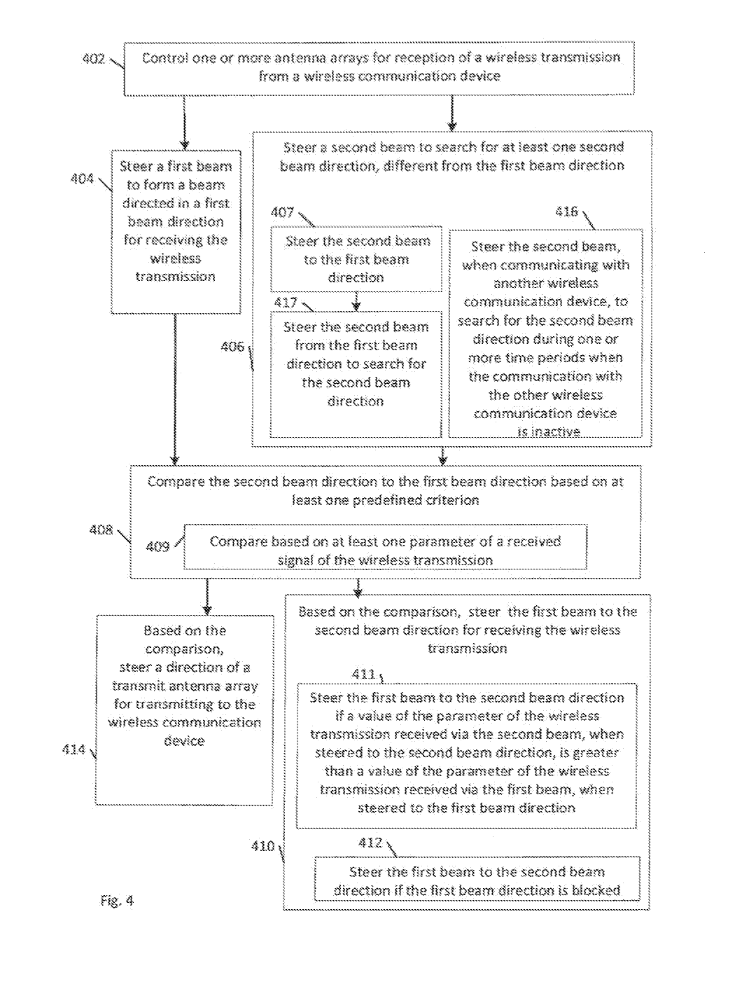

Reference is made to FIG. 4, which schematically illustrates a method of wireless communication utilizing one or more antenna arrays, in accordance with some demonstrative embodiments. In some demonstrative embodiments, one or more of the operations of the method of FIG. 4 may be performed by any suitable wireless communication system, e.g., system 100 (FIG. 1), wireless communication device, e.g., device 102 (FIG. 1) and/or device 104 (FIG. 1), a wireless communication unit, e.g., wireless communication unit 110 (FIG. 1) and/or wireless communication unit 120 (FIG. 1), and/or a controller, e.g., controller 112 (FIG. 1).

As indicated at block 402, the method may include controlling one or more antenna arrays for reception of a wireless transmission from a wireless communication device. For example, controller 112 (FIG. 1) may control one or more antenna arrays 170 (FIG. 1) for reception of wireless transmission 103 (FIG. 1) from wireless communication device 104 (FIG. 1), e.g., as described above.

As indicated at block 404, the method may include steering a first beam to a first beam direction for receiving the wireless transmission. For example, controller 112 (FIG. 1) may steer beam 135 in the first direction for receiving wireless transmission 103 (FIG. 1), e.g., as described above.

As indicated at block 406, the method may include steering a second beam to search for at least one second beam direction, different from the first beam direction. For example, controller 112 (FIG. 1) may steer second beam 145 (FIG. 1) to search for the second beam direction, e.g., as described above.

As indicated at block 407, steering the second beam may include steering the second beam to the first beam direction. For example, controller 112 (FIG. 1) may steer second beam 145 (FIG. 1) to the first beam direction, e.g., as described above.

As indicated at block 417, steering the second beam may include steering the second beam from the first beam direction to search for the second beam direction. For example, controller 112 (FIG. 1) may steer second beam 145 (FIG. 1) from the first beam direction to the second beam direction, e.g., as described above.

As indicated at block 416, steering the second beam may include steering the second beam, when communicating with another wireless communication device, to search for the second beam direction during one or more time periods when the communication with the other wireless communication device is inactive. For example, controller 112 (FIG. 1) may steer second beam 145 (FIG. 1), when communicating with wireless communication device 106 (FIG. 1), to search for the second beam direction during one or more time periods when the communication with wireless communication device 106 (FIG. 1) is inactive, e.g., as described above.

As indicated at block 408, the method may include comparing the second beam direction to the first beam direction based on at least one predefined criterion. For example, controller 112 (FIG. 1) may compare the second beam direction and the first beam direction based on the predefined criterion, e.g., as described above.

As indicated at block 409, comparing the second beam direction to the first beam direction may include comparing the second beam direction to the first beam direction based on at least one parameter related to a received signal of the wireless transmission. For example, controller 112 (FIG. 1) may compare the second beam direction to the first beam direction based on the received signal strength of wireless transmission 103 (FIG. 1), e.g., as described above.

As indicated at block 410, the method may include, based on the comparison, steering the first beam to the second beam direction for receiving the wireless transmission. For example, controller 112 (FIG. 1) may steer first beam 135 (FIG. 1) to the second beam direction based on the comparison, e.g., as described above.

As indicated at block 411, steering the first beam to the second beam direction may include steering the first beam to the second beam direction if a value of the parameter of the wireless transmission received via the second beam, when steered to the second beam direction, is greater than a value of the parameter of the wireless transmission received via the first beam, when steered to the first beam direction. For example, controller 112 (FIG. 1) may steer first beam 135 (FIG. 1) to the second beam direction, if the received signal strength of wireless transmission 103 (FIG. 1) via second beam 145 (FIG. 1), when steered to the second beam direction is greater than the received signal strength of wireless transmission 103 (FIG. 1) via first beam 135 (FIG. 1), when steered to the first beam direction, e.g., as described above.

As indicated at block 412, steering the first beam to the second beam direction may include steering the first beam to the second beam direction if the first beam direction is blocked. For example, controller 112 (FIG. 1) may steer first beam 130 (FIG. 1) to the second beam direction, if the first beam direction is blocked, e.g., as described above.

As indicated at block 414, the method may include steering a direction of a transmit antenna array for transmitting to the wireless communication device based on the comparison. For example, controller 112 (FIG. 1) may steer a direction of transmit antenna array 150 (FIG. 1) for transmitting to wireless communication device 104 (FIG. 1), based on the comparison, e.g., as described above.

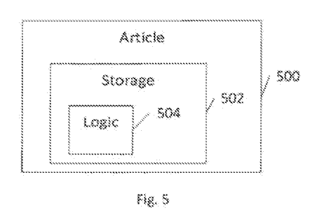

Reference is made to FIG. 5, which schematically illustrates an article of manufacture 500, in accordance with some demonstrative embodiments. Article 500 may include a non-transitory machine-readable storage medium 502 to store logic 504, which may be used, for example, to perform at least part of the functionality of device 102 (FIG. 1), device 104 (FIG. 1), wireless communication unit 110 (FIG. 1), wireless communication unit 120 (FIG. 1), controller 112 (FIG. 1) and/or to perform one or more operations of the method of FIG. 4. The phrase “non-transitory machine-readable medium” is directed to include all computer-readable media, with the sole exception being a transitory propagating signal.

In some demonstrative embodiments, article 500 and/or machine-readable storage medium 502 may include one or more types of computer-readable storage media capable of storing data, including volatile memory, non-volatile memory, removable or non-removable memory, erasable or non-erasable memory, writeable or re-writeable memory, and the like. For example, machine-readable storage medium 502 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 504 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 504 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. An apparatus comprising:
a controller to control one or more antenna arrays for reception of a wireless transmission from a wireless communication device, said controller is to control said one or more antenna arrays to form a first beam directed in a first beam direction for receiving said wireless transmission, and to form a second beam to search for at least one second beam direction, different from said first beam direction, to compare said second beam direction to said first beam direction based on at least one predefined criterion, and, based on said comparison, to steer said first beam to said second beam direction for receiving said wireless transmission.

2. The apparatus of claim 1, wherein said at least one criterion comprises a parameter related to a received signal of said wireless transmission.

3. The apparatus of claim 2, wherein said controller is to steer said first beam to said second beam direction, if a value of said parameter of said wireless transmission received via said second beam, when steered to said second beam direction, is greater than a value of said parameter of said wireless transmission received via said first beam, when steered to said first beam direction.

4. The apparatus of claim 1, wherein said controller is to control said second beam for communicating with another wireless communication device, and wherein said controller is to steer said second beam to search for said second beam direction during one or more time periods when communication with the other wireless communication device is inactive.

5. The apparatus of claim 1, wherein said controller is to steer a direction of a transmit antenna array for transmitting to said wireless communication device based on said comparison.

6. The apparatus of claim 1, wherein said controller is to steer said second beam to said first beam direction and to steer said second beam from said first beam direction to search for said second beam direction.

7. The apparatus of claim 1, wherein said controller is to steer said first beam to said second beam direction if said first beam direction is blocked.

8. The apparatus of claim 7, wherein said first beam direction comprises a line-of-sight (LoS) direction to said wireless communication device.

9. The apparatus of claim 1, wherein said wireless transmission comprises a millimeter-wave (mmwave) transmission.

10. The apparatus of claim 1 comprising an access point.

11. A method comprising:
steering a first beam to a first beam direction for receiving a wireless transmission from a wireless communication device;
steering a second beam to search for at least one second beam direction, different from said first beam direction;
comparing said second beam direction to said first beam direction based on at least one predefined criterion; and
based on said comparison, steering said first beam to said second beam direction for receiving said wireless transmission.

12. The method of claim 11, wherein said at least one criterion comprises at least one parameter related to a received signal of said wireless transmission.

13. The method of claim 12 comprising steering said first beam to said second beam direction, if a value of said parameter of said wireless transmission received via said second beam, when steered to said second beam direction, is greater than a value of said parameter of said wireless transmission received via said first beam, when steered to said first beam direction.

14. The method of claim 11 comprising steering said second beam to said first beam direction and steering said second beam from said first beam direction to search for said second beam direction.

15. The method of claim 11 comprising steering said first beam to said second beam direction if said first beam direction is blocked.

16. The method of claim 15, wherein said first beam direction comprises a line-of-sight (LoS) direction to said wireless communication device.

17. The method of claim 11 comprising communicating with another wireless communication device via said second beam, and steering said second beam to search for said second beam direction during one or more time periods when communication with the other wireless communication device is inactive.

18. The method of claim 11 comprising steering a direction of a transmit antenna array for transmitting to said wireless communication device based on said comparison.

19. A system comprising:
at least a first wireless communication device including:
one or more antenna arrays;
at least first and second Radio Frequency (RF) chains connected to said one or more antenna arrays; and
a controller to control the one or more antenna arrays for reception of a wireless transmission from a second wireless communication device, said controller is to control said one or more antenna arrays to form a first beam directed in a first beam direction for receiving said wireless transmission, and to form a second beam to search for at least one second beam direction, different from said first beam direction, to compare said second beam direction to said first beam direction based on at least one predefined criterion, and, based on said comparison, to steer said first beam to said second beam direction for receiving said wireless transmission.

20. The system of claim 19, wherein said at least one criterion comprises at least one parameter related to a received signal of said wireless transmission.

21. The system of claim 20, wherein said controller is to steer said first beam to said second beam direction, if a value of said parameter of said wireless transmission received via said second beam, when steered to said second beam direction, is greater than a value of said parameter of said wireless transmission received via said first beam, when steered to said first beam direction.

22. The system of claim 19, wherein said controller is to control said second beam for communicating with a third wireless communication device, and wherein said controller is to steer said second beam to search for said second beam direction during one or more time periods when communication with the third wireless communication device is inactive.

23. The system of claim 19, wherein said first wireless communication device comprises at least one transmit antenna array, wherein said controller is to steer a direction of the transmit antenna array for transmitting to said second wireless communication device based on said comparison.

24. The system of claim 19, wherein said wireless transmission comprises a millimeter-wave (mmwave) transmission.

25. The system of claim 19, wherein said first wireless communication device comprises an access point.

26. An article including a non-transitory storage medium having stored thereon instructions that, when executed by a machine, result in:
steering a first beam to a first beam direction for receiving a wireless transmission from a wireless communication device;
steering a second beam to search for at least one second beam direction, different from said first beam direction;
comparing said second beam direction to said first beam direction based on at least one predefined criterion; and
based on said comparison, steering said first beam to said second beam direction for receiving said wireless transmission.

27. The article of claim 26, wherein said at least one criterion comprises at least one parameter related to a received signal of said wireless transmission.

28. The article of claim 27, wherein said instructions result in steering said first beam to said second beam direction, if a value of said parameter of said wireless transmission received via said second beam, when steered to said second beam direction, is greater than a value of said parameter of said wireless transmission received via said first beam, when steered to said first beam direction.

29. The article of claim 26, wherein said instructions result in steering said second beam to said first beam direction and steering said second beam from said first beam direction to search for said second beam direction.

30. The article of claim 26, wherein said instructions result in steering said first beam to said second beam direction if said first beam direction is blocked.
